(19) United States
(12) Patent Application Publication
(10) Pub. No.: US 2019/0002337 A1
(43) Pub. Date: Jan. 3, 2019

(54) APPARATUS INCLUDING A CERAMIC COMPONENT, A METAL COMPONENT, AND A GLASS SEALING MATERIAL AND A PROCESS OF FORMING THE APPARATUS

(71) Applicant: PRAXAIR TECHNOLOGY, INC., Danbury, CT (US)

(72) Inventors: Sean M. Kelly, Pittsford, NY (US); Charles Robinson, West Seneca, NY (US); Javier E. Gonzalez, Rock Hill, SC (US); Lawrence W. Kosowski, West Falls, NY (US); David A. Rich, Nashua, NH (US); Brian C. LaCourse, Pepperell, MA (US); Signo T. Reis, Rolla, MO (US)

(21) Appl. No.: 16/064,531

(22) PCT Filed: Dec. 20, 2016
(86) PCT No.: PCT/US2016/067793

§ 371 Date: Jun. 21, 2018

Related U.S. Application Data
(60) Provisional application No. 62/270,250, filed on Dec. 21, 2015.

(51) Int. Cl. C03C 8/24; C04B 37/02; B32B 15/04; B32B 15/18

(52) U.S. Cl. CPC C03C 8/24; C04B 37/023; B32B 15/04; B32B 15/18; C04B 2237/10; C22C 38/18; C04B 2237/406; C04B 2237/405; C04B 2237/54; C04B 2237/84; C04B 2237/32

(57) ABSTRACT

An apparatus can include a ceramic component, a metal component, and a glass sealing material that bonds the ceramic and metal components to each other. In an embodiment, the coefficients of thermal expansion of the components and glass sealing material can be within 4 ppm/° C. of one another. The metal component may be relatively oxidation resistant. The glass sealing material may have a relatively low amount of an amorphous phase as compared to one or more crystalline phases within the glass sealing material. The apparatuses can exhibit good bond strength even after long term exposure to high temperature, thermal cycling to a high temperature, or both. In an embodiment, the metal component may allow another metal component of a different composition to be used without a significant impact on the integrity of the bonded apparatus.

### GOVERNMENT LICENSE RIGHTS

The invention disclosed and claimed herein was made with United States Government support under Cooperative Agreement number DE-FC26-07NT43088 awarded by the U.S. Department of Energy. The United States Government has certain rights in this invention.

### FIELD OF THE DISCLOSURE

This disclosure relates to apparatuses including a ceramic component, a metal component, and a glass sealing material, and processes of forming the apparatuses.

### BACKGROUND

Joining a ceramic component to a metal component with a high integrity seal can be technically challenging. Many different proposals have suggested particular materials or joining processes. However, a high integrity bond between a ceramic component and a metal component that is stable for a long operating life at a high temperature has been elusive. Thus, further improvement of seals between ceramic and metal components is desired.

### BRIEF DESCRIPTION OF THE DRAWINGS

Embodiments are illustrated by way of example and are not limited in the accompanying figures.

FIG. 1 includes an illustration of a cross-sectional view of an apparatus in accordance with an embodiment disclosed herein.

FIG. 2 includes an illustration of an enlarged view of a portion of the apparatus of FIG. 1 that includes a glass sealing material.

FIG. 3 includes a cross-sectional view of an alternative apparatus in accordance with another embodiment disclosed herein.

FIG. 4 includes chart that includes bonding strengths of apparatuses having different material samples as-bonded and after tests.

FIG. 5 is an illustration of a cross-sectional view of an alternative embodiment of an apparatus disclosed herein.

Skilled artisans appreciate that elements in the figures are illustrated for simplicity and clarity and have not necessarily been drawn to scale. For example, the dimensions of some of the elements in the figures may be exaggerated relative to other elements to help to improve understanding of embodiments of the invention.

### DETAILED DESCRIPTION

The following description in combination with the figures is provided to assist in understanding the teachings disclosed herein. The following discussion will focus on specific implementations and embodiments of the teachings. This focus is provided to assist in describing the teachings and should not be interpreted as a limitation on the scope or applicability of the teachings.

As used herein, compositions of a glass sealing material can be described in terms of molecular formulas or as mol percentages of the constituent metal oxides. For example, sanbornite can be expressed as BaSi₂O₅, BaO.2SiO₂, or as 33.3 mol % BaO and 66.7 mol % SiO₂.

The terms “comprises,” “comprising,” “includes,” “including,” “has,” “having,” or any other variation thereof, are intended to cover a non-exclusive inclusion. For example, a process, method, article, or apparatus that comprises a list of features is not necessarily limited only to those features but may include other features not expressly listed or inherent to such process, method, article, or apparatus. Further, unless expressly stated to the contrary, “or” refers to an inclusive-or and not to an exclusive-or. For example, a condition A or B is satisfied by any one of the following: A is true (or present) and B is false (or not present), A is false (or not present) and B is true (or present), and both A and B are true (or present).

The use of “a” or “an” is employed to describe elements and components described herein. This is done merely for convenience and to give a general sense of the scope of the invention. This description should be read to include one or at least one and the singular also includes the plural, or vice versa, unless it is clear that it is meant otherwise.

Unless otherwise defined, all technical and scientific terms used herein have the same meaning as commonly understood by one of ordinary skill in the art to which this invention belongs. The materials, methods, and examples are illustrative only and not intended to be limiting. To the extent not described herein, many details regarding specific materials and processing acts are conventional and may be found in textbooks and other sources within the arts related to ceramic-to-metal seals.

A high integrity ceramic-to-metal bond can have good long-term characteristics that allow an apparatus to be used for a longer operating, cycled between room temperature and the operating temperature, and still maintain an acceptable good bonding strength and low leak rate.

The inventors have discovered that particular materials and processes can allow for the formation of an apparatus that includes a ceramic component, a metal component, and a glass sealing material that bonds the ceramic and metal components together. The coefficients of thermal expansion (CTEs) can be selected so that all of the CTEs of the ceramic component, metal component, and glass sealing material are within 4 ppm/° C. of one another. The composition of the metal component can be selected so that it does not oxidize too much. When forming the seal, the glass sealing material can be formed such that such material does not have too much of a residual amorphous phase, and thus, the composition of the glass sealing material is more stable when exposed to a high temperature for a long period of time. Furthermore, a lower impurity content within the glass sealing material may help to reduce complications, such as manufacturing repeatability, unintended corrosion of the metal component, or the like. A lower leak rate of the apparatus over the operating life of the apparatus may be achieved at least is part by the limited range of CTEs, limits on oxidation of the metal component, stability of the glass sealing material, another suitable parameter, or any combination thereof.

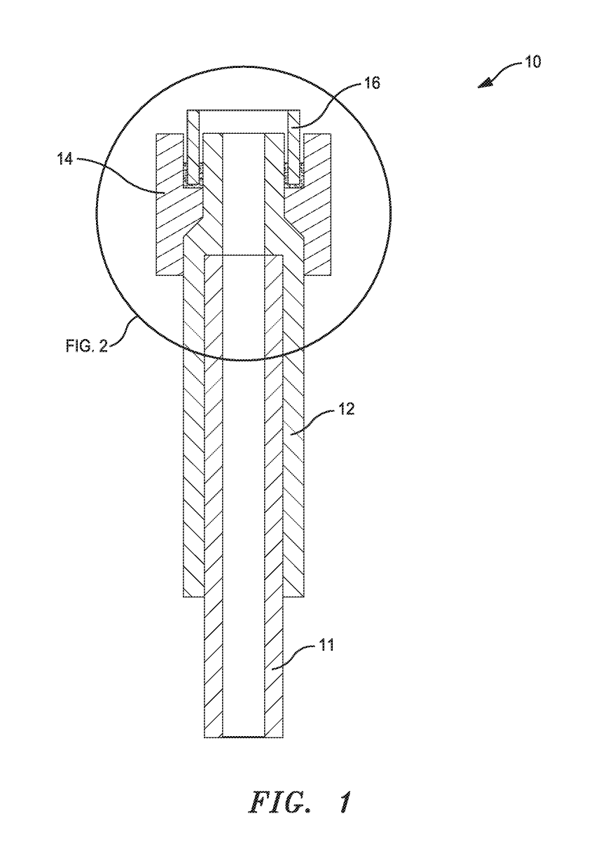

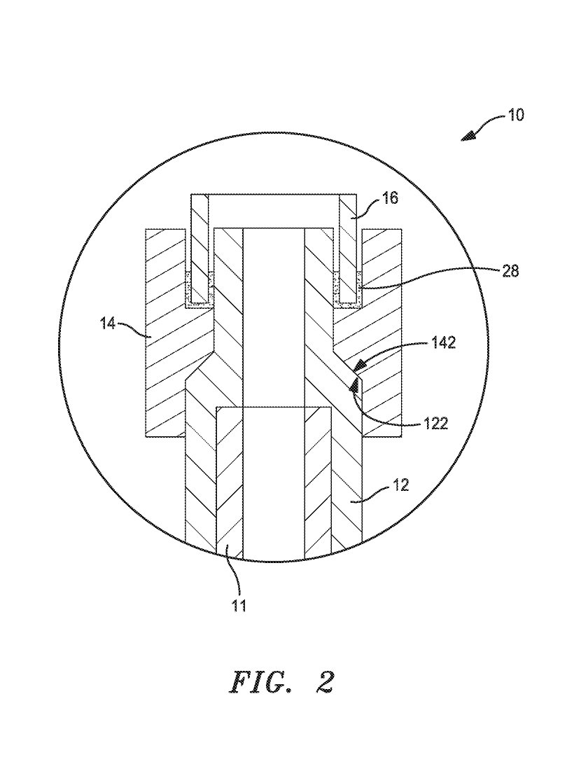

FIG. 1 includes an illustration of a cross-sectional view of a portion of an apparatus 10 that includes a metal component 11, a metal component 12, a ceramic component 14, and a ceramic component 16. FIG. 2 includes an enlarged view to illustrate better a glass sealing material 28 within the apparatus 10. The apparatus 10 can be designed to operate at a relatively high temperature, such as 700° C., 800° C., 900° C. or higher. In an embodiment, the apparatus 10 may be part of or in fluid communication with an oxygen transport membrane, a solid oxide fuel cell, a chemical processing system (e.g., methanol production), or the like.

The metal component 12 can be an adapter that used to provide an inlet gas or an outlet gas for the apparatus 10. The metal component 12 allows the metal component 11 to be used with a significantly lower risk of damaging the apparatus 10 due to a mismatch in coefficients of thermal expansion (CTEs) between the metal component 11 and the other parts of the apparatus 10 that are in contact with the glass sealing material 28.

The use of the metal component 12 allows the metal component 11 to have a CTE that may be problematic if the metal component 12 would have the same composition as the metal component 11. In a particular embodiment, the metal component 11 is a metal tube, and the metal component 12 is an adapter. Thus, the material of the metal component 11 may have a CTE that is more than 4 ppm/° C. different as compared to any one or more of the ceramic components 14 and 16 and the glass sealing material 28. Alternatively, the ceramic side of the apparatus 10 may be exposed at a higher temperature, and therefore, the metal component 11 may not need to have as high of a melting point as the metal component 12. The metal component 11 may be exposed to an oxidizing ambient. An exemplary alloy may include a Ni—Cr alloy having less than 10% Fe, such as an Inconel™-brand alloy, a Ni—Cu alloy, such as a Monel™-brand alloy, or the like. Such materials can have CTEs in a range of 15.0 ppm/° C. to 20.0 ppm/° C.

The metal component 11 can be attached to the metal component 12 by welding, an interference fit, a braze-joint or the like. Welding may or may not be performed with a soldering material or brazing material. The selection of the particular soldering, or brazing material may depend on the compositions of the metal components 11 and 12. For an interference fit, the metal component 11 may fit snuggly into the metal component 12. As the metal components 11 and 12 are taken to a higher temperature, a stronger interference fit may develop between the components 11 and 12, as the metal component 11 expands at a greater rate than the metal component 12. The metal component 11 may or may not extend into the opening of the ceramic component 14.

As illustrated in the embodiment of FIGS. 1 and 2, the metal component 12 has a beveled shoulder 122 that fits into the metal component that also has a beveled shoulder 142. Thus, the shapes of the metal component 12 and the ceramic component 14 complement one another. The shapes of the components 12 and 14 allow for better alignment and control regarding how far the metal component 12 is inserted within the ceramic component 14.

The material for the metal component 12 can be selected to be oxidation resistant. Oxidation resistance can be determined by the amount of weight gain or loss during an oxidation when the material of the metal component is exposed to 1000° C. in air at atmospheric pressure for 500 hours. The mass of the sample used for the oxidation resistance test can be measured before and after the oxidation test. The normalized weight change is calculated by formula ΔWₙ=|(W−Wₒ)|/(500Aₛ), wherein Wₒ is the weight before the test, W is a weight after test, and Aₛ is an outer surface area of the sample. Note that the absolute value of the difference in mass is used. The material may be considered oxidation resistant when the sample has a normalized weight gain less than 0.06 mg/(cm²*hr) or a normalized weight loss less than 0.01 mg/(cm²*hr). Furthermore, the oxidized material should not spall during the oxidation test, as too much spalling material could result in a premature long-term failure. Materials that experience spalling include many alloys that include at least 10 wt % nickel. Exemplary and non-limiting materials that are well suited for the metal component 12 include Fe—Cr alloys that include in a range of 20 wt % to 25 wt. % Cr. The metal component 12 can include an alloy that includes La, Ti, Zr, or any combination thereof, wherein the content of such metals individually or in combination is in a range of 0.05 wt. % to 0.90 wt. %.

The ceramic components 14 and 16 can include yttria-stabilized zirconia (e.g., 1 mol % to 10 mol % Y₂O₃), magnesium aluminate (e.g., magnesium-rich magnesium aluminate (MMA)), lanthanum-doped strontium titanate, lanthanum-doped strontium manganate, or the like. The selection of the ceramic component 14 and 16 may depend more on their compatibility and use in the apparatus 10. For example, the ceramic component 14 can be an adapter, and the ceramic component 16 can be an oxygen transport membrane tube. In another embodiment, the ceramic component 16 or both ceramic components 14 and 16 can be replaced by a manifold for a solid oxide fuel cell. In a further embodiment, one or both of the ceramic components can be different for other applications that involve high temperature operation with an oxidizing gas.

The glass sealing material 28 has a composition that can be selected to have a good CTE match to the other components that it contacts and has good long term stability. With respect to the CTEs, the glass sealing composition 28 should be selected in view of the CTEs of the components 12, 14, and 16. The ceramic components 14 and 16 may have a CTE in a range of 10.0 ppm/° C. to 13.0 ppm/° C. With respect to the metal component 12, a good seal may not be achieved when the metal component 12 exceeds 14 ppm/° C. Materials that include at least 5 wt % Al or are predominantly Ni may have CTEs of 14 ppm/° C. or higher. The metal component 12 can have a CTE is a range of 11.0 ppm/° C. to 13.5 ppm/° C. The glass sealing material 28 can have a CTE in a range of 9.5 ppm/° C. to 13.5 ppm/° C.

Ideally, the CTEs of all components 12, 14, and 16 and the glass sealing material 28 have CTEs that are the same; however, the application in which the apparatus 10 is used may limit the selection of materials, so different CTEs are likely to present because different materials are used. In an embodiment, the CTEs of the components 12, 14, and 16, and the glass sealing material 28 have CTEs that are within 4 ppm/° C. of one another. In another embodiment, a smaller CTE difference may allow for a better seal, and therefore, the CTEs may be within 3 ppm/° C., within 2 ppm/° C., within 1 ppm/° C., or even within 0.5 ppm/° C. In a particular embodiment, the glass sealing material 28 between the CTEs of the components 12, 14, and 16. For example, when the metal component 12 has a CTE of approximately 13 ppm/° C. and the ceramic components have a CTE of approximately 11 ppm/° C., the gas sealing material may have a CTE in a range of 11.5 ppm/° C. to 12.5 ppm/° C.

In an embodiment, the glass sealing material 28 can be of a barium-aluminum-silicon (BAS) class of materials. As initially bonded (hereinafter referred to as “as-bonded”), the glass sealing material 28 can include a sanbornite (BaO.2SiO₂) crystal phase, a hexacelsian (BaO.Al₂O₃.2SiO₂) crystal phase, and may include a residual amorphous phase. The sanbornite crystal phase can have a CTE of approximately 13.0 ppm/° C., and hexacelsian crystal phase can have a CTE of approximately 8.0 ppm/° C., and the residual amorphous phase can have a CTE of approximately 10.0 ppm/° C. A relatively higher content of the sanbornite crystal phase can help to increase the CTE of the glass sealing composition. In an embodiment, the sanbornite crystal phase can be at least 60 vol. %, at least 75 vol. %, or at least 85 vol. %. If the content of the sanbornite crystal phase is too high, the sintering behavior may be adversely affected. In an embodiment, the sanbornite crystal phase may be no greater than 90 vol %. In an embodiment, the hexacelsian crystal phase includes at least 9 vol. %, at least 11 vol. %, or at least 15 vol. % of the glass sealing material 28. If too much of the hexacelsian crystal phase is present, the CTE mismatch, particularly to the metal component 12, may be too great. In an embodiment, the hexacelsian crystal phase is no greater than 40 vol. %, no greater than 30 vol. %, or no greater than 25 vol. % of the glass sealing material 28.

Stability of the glass sealing material 28 can allow for a better integrity seal that lasts for a longer high-temperature operating life. The stability may be affected by the amount of a residual amorphous phase. As will be discussed in more detail later, the glass sealing material 28 can be crystallized to achieve a desired CTE. After the seal is formed, the amorphous phase may crystallize if the apparatus operates at or near a temperature range corresponding to the crystallization temperature of the glass sealing material 28 or if the temperature of the apparatus passes through such temperature range as the apparatus approaches its normal operating temperature range. If all of the glass sealing material 28 is in one or more crystalline phases, the likelihood of the CTE of the glass sealing material changing during high temperature operation can be greatly reduced. Furthermore, the amorphous phase may be more reactive because it is not bound up within a crystalline phase. Thus, the amorphous phase may be more reactive or cause another undesired long term interaction with any one or more of the ceramic and metal components. In an embodiment, the glass sealing material 28 can include an amorphous phase that is not greater than 10 vol. %, not greater than 5 vol. %, not greater than 3 vol. %, not greater than 1 vol % of the glass sealing material. In general, a relatively lower amorphous phase content may help form a more stable bond over the lifetime of the apparatus 10.

Impurities may be present in the starting materials for the glass sealing material 28 or may be intentionally added to the other starting materials. The desired composition of the glass sealing material 28 and the operating environment may have an affect regarding which impurities can be present, and at what amounts. To further complicate matters, an impurity that may be helpful initially as a sintering agent may cause long-term problems. For example, any one or more of the alkali metal oxides, CaO, B₂O₃, and P₂O₅ may help with wetting, flowing, or crystallization of the glass sealing material 28; however, such materials may be corrosive when in the presence of water vapor at a high temperature. In an embodiment, SrO, TiO₂, ZrO₂, or any combination thereof may be added to improve the composition with a reduced likelihood of adverse affects as compared to many other commonly added impurities

With respect to metal oxides within the glass sealing material 28, in an embodiment, the amount of SiO₂ can be in a range of 60 mol % to 65 mol %, and in a particular embodiment, in a range of 62 mol % to 63 mol %. In an embodiment, the amount of BaO can be in a range of 25 mol % to 35 mol %, and in a particular embodiment in a range of 30 mol % to 32 mol %. In an embodiment, the amount of Al₂O₃ can be in range of 3 mol % to 15 mol %, and in a particular embodiment, in a range of 5 to 10 mol %. The total amount of SrO, TiO₂, and ZrO₂, if any one or more are present, may be no greater than 4 mol %. In a particular embodiment, SrO, TiO₂, and ZrO₂ are not added as an intentional impurity. In another particular embodiment, the glass sealing material 28 includes 0.5 mol % to 2 mol % SrO. In an embodiment, other than SrO, TiO₂, and ZrO₂ (if any are present), the glass sealing material 28 comprises no greater than 1 mol % of such other impurities.

Controlling the ratios of the SiO₂, BaO, and Al₂O₃ may help to keep the amount of the residual amorphous phase relatively low. The molar ratio of SiO₂:BaO can be in a range of 1.5:1 and about 3:1, and in a particular embodiment, is in a range of 1.8:1 to 2.2:1. The molar ratio of SiO₂:Al₂O₃ can be in a range of 3:1 to 7:1, and in a particular embodiment, in a range of 4:1 to 6:1.

A process of forming the apparatus 10 can include preparing the components and materials before bonding the components together. The ceramic components 14 and 16 can be formed as green objects and fired to form the ceramic components 14 and 16. The metal component 12 may be oxidized to help make the glass sealing composition 28 adhere better. In this optional embodiment, the metal component 12 may be exposed to an oxidizing ambient, such as air, oxygen, or the like, at a temperature in a range of 900° C. to 1200° C., and a time in a range of 10 minutes to 120 minutes. The metal component 12 may be heated and cooled at a rate in the range of 1° C./min. to 10° C./min. The resulting oxide has a thickness in a range of 1 micron to 20 microns. The metal component 11 may be joined to the metal component 12 before or after bonding the metal component 12 to the ceramic components 12 and 14.

The glass sealing material 28 can be formed from glass precursor materials. The amounts of the precursors are selected to achieve the composition of the glass sealing material 28 as previously described. The glass precursor materials can include SiO₂, Al₂O₃, and BaO and can be prepared, for example, by melting powder mixtures containing the appropriate amounts, described in details below, of pre-fired Al₂O₃, barium carbonate (BaCO₃ can decompose into BaO and CO₂), and SiO₂. Melting can be conducted in a joule-heated platinum crucible at a temperature in a range of 1500° C. to 1600° C. The melt can be allowed to refine for a time period in a range of 1 hour to 3 hours before being water quenched, resulting in a glass frit. The glass frit can be milled and screened to produce a glass powder having an average particle size in a range of 0.5 to 10 microns, such as in a range of 0.7 to 4 microns. The glass powder can be mixed with a polymeric binder and an organic solvent to produce a slurry of glass particles.

The slurry of glass particles can be placed on one or more of the component 12, 14, and 16 of the apparatus 10. Alternatively, at least some of the components may be assembled before applying the slurry of glass particles. For example, the stem of the metal component 12 may be inserted into an opening of the ceramic component 14 before the slurry of glass particles is applied. The ceramic component 16 may then be placed into position after the slurry of glass particles has been applied.

After the components are in place and the slurry of glass particles is applied, the apparatus 10 is annealed to form the bond. The bonding operation can include seal formation and crystallization to adjust the CTE of the glass sealing material 28. After the polymeric binder and organic solvent are burned out, the apparatus 10 is heated to densify and flow the glass to form the seal. The temperature and time for the seal formation may depend on glass composition. In an embodiment, the temperature for the seal formation is at least 950° C., at least 1050° C., or at least 1150° C., or at least 1210° C., or at least 1230° C., or at least 1250° C., and in another embodiment, the temperature for the seal formation is not greater than 1360° C., or not greater than 1310° C., or not greater than 1280° C. In a particular embodiment, the temperature for the seal formation is in a range of 950° C. to 1360° C., or in a range of 1050° C. to 1310° C., or in a range of 1150° C. to 1280° C. The time for seal formation may depend on the temperature. In an embodiment, the time is at least 0.5 minute, at least 2 minutes, or at least 5 minutes, and in another embodiment, the time is not greater than 120 minutes, not greater than 55 minutes, or not greater than 20 minutes. In a particular embodiment, the time is in a range of 0.5 minute to 120 minutes, 2 minutes to 55 minutes, or 5 minutes to 20 minutes.

In an embodiment, the crystallization temperature and time may depend on the glass composition. In an embodiment, the temperature for crystallization is at least 800° C., at least 825° C., or at least 850° C., and in another embodiment, the temperature for crystallization is not greater than 1050° C., not greater than 1000° C., or not greater than 950° C. In a particular embodiment, the crystallization temperature is in a range of 800° C. to 1050° C., or in a range of 825° C. to 950° C., or in a range of 850° C. to 950° C. The time for crystallization may depend on the temperature. In an embodiment, the time for crystallization is at least 1.1 hours, at least 2.5 hours, at least 3 hours, at least 4 hours, and in another embodiment, the time for crystallization is not greater than 9.5 hours, not greater than 8.5 hours, not greater than 7 hours, or not greater than 6 hours. In a particular embodiment, the time for crystallization is in a range of 1.1 hours to 9.5 hours, in a range of 2.5 hours to 8.5 hours, in a range of 3 hours to 7 hours, or in a range of 4 hours to 6 hours. After crystallization is performed, most of the glass sealing composition should be in one or more crystalline phases, and only a relatively small amount of the glass sealing composition will be in a residual amorphous phase. A relatively small amount of residual amorphous phase can help form a bond that is more stable over the normal operating life of the apparatus.

Tests can be performed on the apparatus to test the bond strength. One test is performed on an as-bonded apparatus. Another test is performed on bonded apparatuses that have been temperature cycled for five (5) times, wherein for each cycle, the bonded apparatus is heated to 1000° C. at a ramp rate of 5° C./minute and cooled to 22° C. at a ramp rate of 5° C./minute. In an aging test, the bonded apparatuses are heated to 1050° C. for 1000 hours. In the aging test, the bonded apparatuses were heated at a ramp rate of 5° C./minute and cooled to 22° C. at a ramp rate of 5° C./minute. Each of the cycling and aging tests are performed in air at atmospheric pressure. Each apparatus is held at a flat portion of the ceramic component 14 (closer to the bottom of FIGS. 1 and 2) and along the stem of the metal component 12, and then the apparatus is pulled apart to determine bond strength (i.e., force applied just before a failure under tensile stress occurs). The bond strength testing is performed at atmospheric conditions. The cycling and aging test can result in a lower bonding strength for the apparatus compared to the as-bonded apparatus. The loss in bond strength can be calculated using the following formulas:

((s_{as-bonded}−s_{cycled})/s_{as-bonded})×100% for the cycling test; or

((s_{as-bonded}−s_{aged})/s_{as-bonded})×100% for the aging test,

wherein:

s_{as-bonded} is the force needed to separate an as-bonded apparatus;

s_{as-cycled} is the force needed to separate an apparatus after the cycling test; and

s_{as-bonded} is the force needed to separate an apparatus after the aging test.

If more than one apparatus is tested, the average bond strength values can be used.

A lower loss in bond strength can indicate that a bond has better integrity and stability over the high-temperature operating life of the apparatus. In an embodiment, the loss in bond strength of the apparatus after the cycling or aging test is not greater than not greater than 50%, or not greater than 40%, or not greater than 35%, or not greater than 30%, or not greater than 25%, or not greater than 10%, or not greater than 5%.

The leakage of rate associated with the apparatus can be determined by measuring the flow coefficient (Cv) at an interface of the ceramic component, the metal component, and the glass sealing material. Cv may be not greater than 1×10⁻⁵, not greater than 5×10⁻⁶, or not greater than 1×10⁻⁶.

The goal of leak testing in oxygen transport membrane (OTM) components is to characterize the leak in the form of an equivalent flow coefficient, Cᵥ. This permits comparison and estimation of leak rate at different conditions (e.g., temperature, pressure, gas type). Cᵥ is determined by measuring the flow rate of the leak, in conjunction with the pressure on both sides of the leaking sample. Temperature and gas specific gravity also affected the calculated Cᵥ.

The flow coefficient is commonly used in the valve supply and manufacturing industry and a comprehensive review of the equations used to calculate Cᵥ can be found in the Valve Sizing technical bulletin (MS-06-84) available from Swagelok®. Determining Cᵥ was performed in one of two flow regimes, low pressure drop or high pressure drop in accordance with the aforementioned bulletin. For the low pressure drop flow regime, when the absolute pressure upstream of the leak was less than twice the absolute pressure downstream of the leak, subsonic flow will be present at the leak orifice and, the following equation is applicable:

$${C}_{v} = \frac{q}{{N}_{2} {p}_{1} ( 1 - \frac{2 ( {p}_{1} - {p}_{2} )}{3 {p}_{1}} ) \sqrt{\frac{( {p}_{1} - {p}_{2} )}{{p}_{1} {G}_{g} {T}_{1}}}}$$

For the high pressure drop flow regime, when the pressure upstream of the leak was more than twice the pressure downstream of the leak, the following equation was applicable:

$${C}_{v} = \frac{q}{0.471 {N}_{1} {p}_{1} \sqrt{\frac{1}{{G}_{g} {T}_{1}}}}$$

For both of the equations above:

Cᵥ=flow coefficient, q=gas flow, std L/min

N₂=6950

p₁=pressure upstream of leak, bar (absolute)

p₂=pressure downstream of leak, bar (absolute)

T₁=temperature, K

G_{g}=gas specific gravity (air=1.0)

Measuring the Cᵥ of OTM components was typically performed at ambient temperature, using a non-flammable gas. For example, the measured leak rate of an OTM component was 0.6 slpm of air at 20 C, with an upstream pressure of 50 psig (4.4 bar) and downstream pressure of 0 psig (1 bar). Using the above equation for high pressure drop flow regime, the Cᵥ of this leak was roughly 7E-4. Once the equivalent Cᵥ of a leak was measured, it could be used to calculate the leak rate at any other set of conditions. Using the Cᵥ calculated above (i.e., 7E-4), the estimated leak rate at 500 C, with P₁=200 psig and P₂=0 psig, would be 1.6 slpm of methane (G_{g}=16/29=0.55).

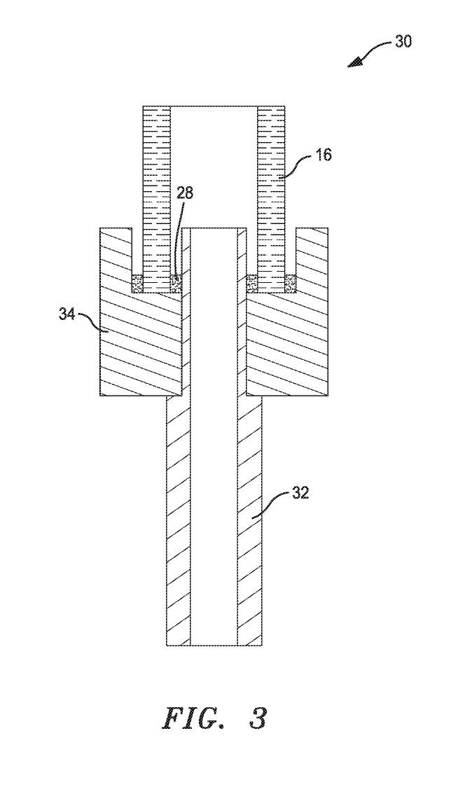

The improvements seen with the apparatus as illustrated in FIGS. 1 and 2 may be seen with other apparatuses. FIG. 3 includes an illustration of an apparatus 30 in which the metal components 11 and 12 are replaced by the metal component 32, and the ceramic component 14 is replaced by ceramic component 34. The materials for the metal component 32 and the ceramic component may be any of the materials as described with respect to the metal component 12 and the ceramic component 14. Other designs can be used to meet the needs or desires for particular applications.

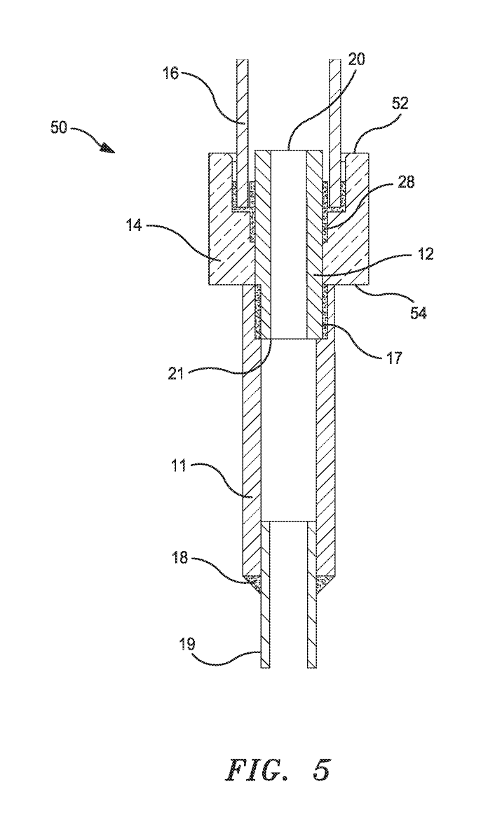

FIG. 5 describes a further embodiment directed to mitigating the problems associated the high stress, and high potential creep-strain areas in ceramic-metal joints or seals. FIG. 5 describes an apparatus which comprises a dense ceramic adaptor 14 disposed between the ceramic component 16 and the metal connector 12. In this embodiment the ceramic component 16 is a tubular ceramic oxygen transport membrane. The ceramic membrane adaptor 14 is a tubular shaped adaptor that includes a first female end 52 configured to receive a ceramic oxygen transport membrane tube 16 and a second female end 54 configured to engage or receive the corresponding a first or proximal end 20 of the first metal component or connector 12. Component 12 forms a first metal component, with a thermal expansion rate most compatible with the adjoining glass, 28, and adjoining ceramic components 14, and 16. The dense ceramic adaptor 14 also has a coefficient of thermal expansion that is matched or closely matched to the coefficient of thermal expansion of the ceramic tubular oxygen transport membrane 16. More importantly, the dense ceramic adaptor 14 is designed so as to absorb much of the stress that is caused by the differential thermal expansion characteristics between the ceramic parts and first metal tube or connector 12.

The second or distal end 21 of said first metal component 12 is configured to engage the corresponding female or proximal end of said second metal component or connector 11. In one embodiment, the second metal tubular connector has a larger diameter and is configured to receive at least a portion of said first tubular metal connector that is extending from the dense ceramic adaptor, wherein said first and second tubular metal connectors are joined with a braze material forming a joint between at least a portion of the overlapping surfaces of said first and second tubular metal connectors. Preferably in this configuration, the total length of first metal component 12 that is exposed with no overlap by either the ceramic component 14, or the said second metal component 11 is as small as possible, and not more than 0.75 mm.

Alternatively, the second metal connector, 11, is of the same diameter of said first metal connector, 12, and the two connectors are butt-welded forming a joint, wherein said joint is fully incorporated within the internal bore of the dense ceramic adaptor, 14, such that the creep strain of said metal component 11, under internal pressurization is minimized or retarded by the surrounding dense ceramic adaptor 14.

Metal component 11 is comprised of an alloy with a higher tensile and creep strain resistance than metal component 12, but with a resulting higher thermal expansion rate such as Incolloy 800 HT (TNS N08811).

A glass ceramic bonding agent or sealing material 28, as described above, is placed at or near the interface of the ceramic adaptor 14 and the metal connector 12, and more particularly proximate the annular sheath structure. When heated according to the process described herein, the glass-ceramic material 28 flows into or wets the interface between adjoining surfaces of the ceramic membrane adaptor 14 and the metal connector 12 as well as into the annular sheath structure forming a joint between at least a portion of the overlapping surfaces.

A nickel-braze material such as WallColmonoy Nicrobraz LM alloy (BNi-2, AMS 4777) comprises a joint 17 between first metal component 12 and second metal component 11. Various brazing techniques, including high temperature nickel-vacuum furnace brazing, is well established in the art and the furnace cycle specified here is typical for the specified alloys. A third metal component, 19, comprising a similar metal as metal component 11, and forming the fluidic connection to the rest of the system is configured to join the distal end of metal component 11. The third metal connector has a smaller diameter and is configured to insert into the bore of said second metal connector, 11, wherein said third and second metal connectors are joined with a nickel-braze material melted and diffused through a furnace or resistance-heating process, or a non-filler-metal weld such as is formed with an orbital Tungsten-Inert-Gas (TIG) process forms a joint 18 between said second and third metal components comprising manifold connection pathways to the rest of the system.

Alternatively, the third metal connector, 19, could be of the same diameter of said second metal connector 12 and the two connectors can be butt-welded thus forming a joint between the two connectors.

In one embodiment the first and second metal (12 and 11) components are made and brazed together first. These become a new joint component that is then glass-sealed to tube 16 and adaptor 14 in a separate heating process. Then as a last step in the assembly, third metal component 19 is introduced, and welded or brazed through a 3^{rd} heating process. Joint formation between the various connectors and adapters do not have to occur in the same place or at the same time.

The ceramic membrane adaptor 14 also defines a central bore running between the first female end 52, second female end 54, and through the metal connectors and which communicates with the interior of the oxygen transport membrane tube. Similar to other embodiments, the ceramic components, the metal connectors, and the glass sealing material has a coefficient of thermal expansion that is within 4 ppm/° C. of one another, in another embodiment within 3 ppm/° C., in another embodiment within 2 ppm/° C., in still another embodiment within 1 ppm/° C., or in yet another embodiment within 0.5 ppm/° C.

In one embodiment said second tubular metal connector is composed of a different material than said first tubular metal connector, wherein said material has higher strength at temperatures of from about 750° C. to about 1025° C. than the material of said first tubular metal connector.

Many different aspects and embodiments are possible. Some of those aspects and embodiments are described below. After reading this specification, skilled artisans will appreciate that those aspects and embodiments are only illustrative and do not limit the scope of the present invention. Exemplary embodiments may be in accordance with any one or more of the ones as listed below.

### Embodiment 1

An apparatus includes a ceramic component; a glass sealing material; and a metal component bonded to the ceramic component via the glass sealing material, wherein:
each of the ceramic component, the metal component, and the glass sealing material has a coefficient of thermal expansion that is within 4 ppm/° C. of one another, and
the metal component has a normalized weight gain less than 0.06 mg/(cm²*hr) or a normalized weight loss less than 0.01 mg/(cm²*hr), wherein the weight gain or the weight loss is calculated by formula ΔWₙ=|(W−Wₒ)|/(500Aₛ), wherein Wₒ is an original weight of the metal component, W is a weight after the metal component is exposed to 1000° C. in air at atmospheric pressure for 500 hours, and Aₛ is an outer surface area of the metal component.

### Embodiment 2

An apparatus includes a ceramic component; a glass sealing material; and a metal component bonded to the ceramic component via the glass sealing material, wherein a loss in a bond strength of the apparatus is not greater than 50% after exposure of the apparatus to 1050° C. for 1000 hours or 5 cycles of a temperature change between 22° C. and 1000° C. at a ramp up rate of 5° C./min. and a ramp down rate of 5° C./min.

### Embodiment 3

A process of forming an apparatus includes providing a ceramic component and a metal component; placing a glass sealing material between the ceramic component and the metal component; and heating the glass sealing material to form a bond between the ceramic component and the metal component, wherein:
each of the ceramic component, the metal component, and the glass sealing material has a coefficient of thermal expansion that is within 4 ppm/° C. of one another, and
the metal component has a normalized weight gain less than 0.06 mg/cm²/hr or a normalized weight loss less than 0.01 mg/(cm²*hr), wherein the weight gain or the weight loss is calculated by formula ΔWₙ=(W−Wₒ)/(500Aₛ), wherein Wₒ is an original weight of the metal component, W is a weight after the metal component is exposed to 1000° C. in air at atmospheric pressure for 500 hours, and Aₛ is an outer surface area of the metal component.

### Embodiment 3A

An apparatus for forming a joint between a tubular ceramic component and a plurality metal component, said apparatus comprising:
a dense ceramic adapter;
a first tubular metal connector comprising proximate and distal ends wherein at least a portion of said first metal connector is contained within the bore of said dense ceramic adapter,
a second metal connector configured to receive or form a joint with said first tubular metal connector, and
a glass-ceramic sealing material,
wherein said dense ceramic adapter comprises a first female end configured to receive said tubular ceramic component, and a second female end configured to receive the proximal end of said first tubular metal connector, and
wherein the distal end of said first tubular metal connector is configured to engage the corresponding proximal end of said second tubular metal connector,
wherein said glass-ceramic seal material is disposed between the adjacent surfaces of said tubular ceramic component, said dense ceramic adaptor, and said first tubular metal connector thus forming a joint between said adjacent surfaces.

### Embodiment 4

The process of Embodiment 3 or 3A, further including forming an oxidized layer adjacent to the metal component.

### Embodiment 5

The process of Embodiment 4, wherein forming the oxidized layer is performed prior to placing the glass sealing material.

### Embodiment 6

The process of any one of Embodiments 3 to 5, wherein heating the glass sealing material includes heating the glass sealing material at a first temperature and heating the glass sealing material at a second temperature that is different than the first temperature.

### Embodiment 7

The process of Embodiment 6, wherein heating the glass sealing material at the second temperature is performed to crystalize the glass sealing material.

### Embodiment 8

The process of Embodiment 6 or 7, wherein the first temperature is greater than the second temperature.

### Embodiment 9

The process of any one of Embodiments 6 to 8, wherein the first temperature is at least 950° C., at least 1030° C., at least 1050° C., or at least 1150° C., or at least 1210° C., or at least 1230° C., or at least 1250° C.

### Embodiment 10

The process of any one of Embodiments 6 to 9, wherein the first temperature is not greater than 1360° C., or not greater than 1310° C., or not greater than 1280° C.

### Embodiment 11

The process of any one of Embodiments 6 to 10, wherein the first temperature is in a range of 930° C. to 1360° C., or in a range of 1050° C. to 1310° C., or in a range of 1150° C. to 1280° C.

### Embodiment 12

The process of any one of Embodiments of 6 to 11, wherein the second temperature is at least 800° C., or at least 825° C., or at least 850° C.

### Embodiment 13

The process of any one of Embodiments of 6 to 12, wherein the second temperature is not greater than 1050° C., or not greater than 1000° C., or not greater than 950° C.

### Embodiment 14

The process of any one of Embodiments of 6 to 13, wherein the second temperature is in a range of 800° C. to 1050° C., or in a range of 825° C. to 1000° C., or in a range of 850° C. to 950° C.

### Embodiment 15

The process of any one of Embodiments 6 to 14, wherein heating at the first temperature is performed for at least 0.5 minute, or at least 2 minutes, or at least 5 minutes. 16. The process of any one of Embodiments 6 to 15, wherein heating at the first temperature is performed for not greater than 120 minutes, or not greater than 55 minutes, or not greater than 20 minutes.

### Embodiment 16

The process of any one of Embodiments 6 to 15, wherein heating at the first temperature is performed for a period of time in a range of 0.5 minute to 120 minutes, or in a range of 2 minutes to 55 minutes, or in a range of 5 minutes to 20 minutes.

### Embodiment 17

The process of any one of Embodiments 6 to 16, wherein heating at the second temperature is performed for at least 1.1 hours, or at least 2.5 hours, or at least 3 hours, or at least 4 hours.

### Embodiment 18

The process of any one of Embodiments 6 to 17, wherein heating at the second temperature is performed for not greater than 9.5 hours, or not greater than 8.5 hours, or not greater than 7 hours, or not greater than 6 hours.

### Embodiment 19

The process of any one of Embodiments 6 to 18, wherein heating at the second temperature is performed for a period time in a range of 1.1 hours to 9.5 hours, or in a range of 2.5 hours to 8.5 hours, or in a range of 3 hours to 7 hours, or in a range of 4 hours to 6 hours.

### Embodiment 20

The apparatus or process of any one of Embodiments 1 and 3 to 19, wherein a loss in a bond strength of the apparatus is not greater than 50% after exposure of the apparatus to 1050° C. for 1000 hours or 5 cycles of a temperature change between 22° C. and 1000° C. at a ramp up rate of 5° C./min. and a ramp down rate of 5° C./min.

### Embodiment 21

The apparatus or process of any one of the preceding Embodiments, wherein a loss in a bond strength of the apparatus is not greater than 50%, or not greater than 40%, or not greater than 35%, or not greater than 30%, or not greater than 25%, or not greater than 10%, or not greater than 5% after exposure of the apparatus to 1050° C. for 1000 hours.

### Embodiment 22

The apparatus or process of any one of the preceding Embodiments, wherein a loss in a bond strength of the apparatus is not greater than 50%, or not greater than 40%, or not greater than 35%, or not greater than 30%, or not greater than 25%, or not greater than 10%, or not greater than 5% after exposure of the apparatus to 5 cycles of a temperature change between 22° C. and 1000° C. at a ramp up rate of 5° C./min. and a ramp down rate of 5° C./min.

### Embodiment 23

The apparatus or process of any one of the preceding Embodiments, wherein the metal component has a normalized weight loss not greater than 0.001 mg/(cm²*hr), not greater than 0.0005 mg/cm²/hr, or not greater than 0.0001 mg/(cm²*hr.).

### Embodiment 24

The apparatus or process of any one of the preceding Embodiments, wherein the metal component includes an alloy including Cr and Fe.

### Embodiment 25

The apparatus or process of any one of the preceding Embodiments, wherein the metal component includes an alloy including La, Zr, Ti, or any combination thereof.

### Embodiment 26

The apparatus or process of Embodiment 26, wherein a content of La, Zr, Ti, or any combination thereof within the alloy is in a range of 0.05 wt. % to 0.90 wt. %.

### Embodiment 27

The apparatus or process of any one of the preceding Embodiments, wherein the metal component includes an alloy that does not include W, Nb, or N.

### Embodiment 28

The apparatus or process of any one of the preceding Embodiments, wherein the metal component includes an alloy including Al in an amount of 1 wt % to 5.5 wt % relative to a total weight of the alloy.

### Embodiment 29

The apparatus or process of any one of the preceding Embodiments, wherein the ceramic component includes a material including a stabilized zirconia, a magnesia magnesium aluminate, a lanthanum-doped strontium titanate, a lanthanum-doped strontium manganate, or a combination thereof.

### Embodiment 30

The apparatus or process of any one of the preceding Embodiments, wherein the glass sealing material includes an oxide of Si, Ba, Al, or any combination thereof.

### Embodiment 31

The apparatus or the process of any one of the preceding Embodiments, wherein the glass sealing material of the seal as initially formed includes an amorphous phase that is not greater than 10 vol. %, not greater than 5 vol. %, not greater than 3 vol. %, not greater than 1 vol %.

### Embodiment 32

The apparatus or the process of any one of the preceding Embodiments, wherein the glass sealing material of the seal includes a sanbornite phase, a hexacelsian phase, and a barium aluminum silicate phase.

### Embodiment 33

The apparatus or the process of Embodiment 33, wherein the glass sealing material of the seal includes no greater than 5 wt %, no greater than 3 wt %, or no greater than 1 wt % of impurities.

### Embodiment 34

The apparatus or the process of any one of the preceding Embodiments, wherein the sealing material includes at least 50 mol % SiO₂, 25 mol % to 50 mol % BaO, and 1.1 mol % to 15 mol % Al₂O₃.

### Embodiment 35

The apparatus or the process of any one of the preceding Embodiments, wherein the sealing material includes 60 mol % to 64 mol % SiO₂, 30 mol % to 32 mol % BaO, and 5 mol % to 8 mol % Al₂O₃.

### Embodiment 36

The apparatus or process of any one of Embodiments 31 to 36, wherein the glass sealing material further includes SrO, TiO₂, ZrO₂, or any combination thereof.

### Embodiment 37

The apparatus or process of Embodiment 37, wherein the glass sealing material includes 0.5 mol % to 2 mol % SrO.

### Embodiment 38

The apparatus or the process of any one of the preceding Embodiments, wherein the ceramic component has a coefficient of thermal expansion in a range of 10.0 ppm/° C. to 13.0 ppm/° C.

### Embodiment 39

The apparatus or the process of any one of the preceding Embodiments, wherein the metal component has a coefficient of thermal expansion in a range of 11.0 ppm/° C. to 13.5 ppm/° C.

### Embodiment 40

The apparatus or the process of any one of the preceding Embodiments, wherein the glass sealing material has a coefficient of thermal expansion in a range of 9.5 ppm/° C. to 13.5 ppm/° C.

### Embodiment 41

The apparatus or the process of any one of the preceding Embodiments, wherein each of the ceramic component, the metal component, and the glass sealing material has a coefficient of thermal expansion that is within 3 ppm/° C. of one another, or within 2 ppm/° C., or within 1 ppm/° C., or within 0.5 ppm/° C.

### Embodiment 42

The apparatus or the process of any one of the preceding Embodiments, wherein the apparatus has a flow coefficient (Cv) at an interface of the ceramic component, the metal component, and the glass sealing material of not greater than 1×10⁻⁵, not greater than 5×10⁻⁶, or not greater than 1×10⁻⁶.

### Embodiment 43

The apparatus or the process of any one of the preceding Embodiments, wherein the apparatus includes a solid oxide fuel cell system, an oxygen transport membrane system, a chemical processing system, or a combination thereof.

### Embodiment 44

The apparatus or the process of any one of the preceding Embodiments, wherein the ceramic component includes a solid oxide fuel cell, a manifold, an adaptor, or a combination thereof.

### Embodiment 45

The apparatus or the process of any one of the preceding Embodiments, wherein the metal component comprises a gas delivery tube, an adaptor, a manifold, or a combination thereof.

### Examples

The examples formed in accordance with embodiments as described above are presented to demonstrate that apparatuses with good bonds that perform well in view of tests that can reflect good long-term operating lifetime for the apparatuses. The examples are intended to illustrate and not limit the scope of the appended claims.

Example 1 was performed to determine how different metal compositions for the metal component 16 performed in bonding and oxidation tests. Table 1 summarizes the results of the apparatuses for different materials for the metal component 16. To the extent notable elements are listed without a value, the content is in a range 0.01 wt % to 1 wt %. Note that other impurities may be present but are not noted in Table 1. For example, C is present in the steel compositions but is not listed. The composition of the ceramic components and glass sealing material were the same for all apparatuses to allow for a better comparison between the materials.

| | | CTE, | |
|---|---|---|---|
| | | 20° C.-1000° C. | |
| Sample | Material | (ppm/° C. | Comments |
| A | Fe—Cr | 13.3 | Leak tight, |
| | (21-23 wt. % Cr, | | no spalling |
| | La, Zr) | | |
| B | Fe—Cr | 12.7 | Leak tight, |
| | (20-24 wt. % Cr, | | no spalling |
| | La Ti) | | |
| C | Fe—Cr | 12.8 | Leak tight, |
| | (20-24 wt. % Cr, | | no spalling |
| | La, Ti, W, Nb) | | |
| D | Fe—Cr | 12.4 | Oxidation/spalling, |
| | (16-18 wt. % Cr) | | no bond |
| E | Fe—Cr | 15.5 | Leaky bond, CTE |
| | (20.5-23.5 wt. % | | mismatch |
| | Cr, 5.8 wt. % Al) | | |
| F | Fe—Ni—Cr | 11.3 | Oxidation/spalling, |
| | | | no bond |
| G | Cr—Ni—Mo | 12.8 | Oxidation/spalling, |
| | | | no bond |
| H | Ni | 16.1 | Leaky bond, CTE |
| | | | mismatch |
| I | Ni | 15.0 | Oxidation/spalling, |
| | | | no bond |
| J | Ni | 18.2 | Leaky bond, CTE |
| | | | mismatch |

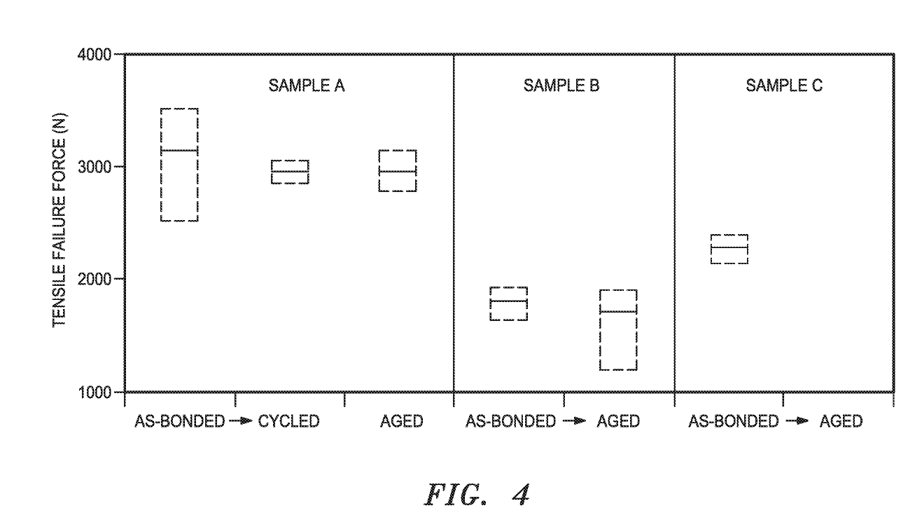

Samples A, B, and C were subjected to aging tests, and Sample A was subjected to a cycling test. FIG. 4 includes the data for the as-bonded, aged, and cycled samples. Each of Samples A and B exhibited a bond strength loss of approximately 5% after the aging test, and Sample A exhibited a bond strength loss of approximately 5% after the cycling test. Sample C did not have any significant bond strength after the aging test, and the presence of W. Each of Samples B and C exhibited a little evidence of spalling. Thus, the Sample A is a very good material for the metal component, and Sample B is not as good as Sample A, but it is still a good material for the metal component.

Note that not all of the activities described above in the general description or the examples are required, that a portion of a specific activity may not be required, and that one or more further activities may be performed in addition to those described. Still further, the order in which activities are listed is not necessarily the order in which they are performed.

Certain features that are, for clarity, described herein in the context of separate embodiments, may also be provided in combination in a single embodiment. Conversely, various features that are, for brevity, described in the context of a single embodiment, may also be provided separately or in any subcombination. Further, reference to values stated in ranges includes each and every value within that range.

Benefits, other advantages, and solutions to problems have been described above with regard to specific embodiments. However, the benefits, advantages, solutions to problems, and any feature(s) that may cause any benefit, advantage, or solution to occur or become more pronounced are not to be construed as a critical, required, or essential feature of any or all the claims.

The specification and illustrations of the embodiments described herein are intended to provide a general understanding of the structure of the various embodiments. The specification and illustrations are not intended to serve as an exhaustive and comprehensive description of all of the elements and features of apparatus and systems that use the structures or methods described herein. Separate embodiments may also be provided in combination in a single embodiment, and conversely, various features that are, for brevity, described in the context of a single embodiment, may also be provided separately or in any subcombination. Further, reference to values stated in ranges includes each and every value within that range. Many other embodiments may be apparent to skilled artisans only after reading this specification. Other embodiments may be used and derived from the disclosure, such that a structural substitution, logical substitution, or another change may be made without departing from the scope of the disclosure. Accordingly, the disclosure is to be regarded as illustrative rather than restrictive.

1. An apparatus, comprising:
a ceramic component;
a glass sealing material; and
a metal component bonded to the ceramic component via the glass sealing material,
wherein:
each of the ceramic component, the metal component, and the glass sealing material has a coefficient of thermal expansion that is within 4 ppm/° C. of one another, and
the metal component has a normalized weight gain less than 0.06 mg/(cm²*hr) or a normalized weight loss less than 0.01 mg/(cm²*hr), wherein the weight gain or the weight loss is calculated by formula ΔWₙ=|(W−Wₒ)|/(500Aₛ), wherein Wₒ is an original weight of the metal component, W is a weight after the metal component is exposed to 1000° C. in air at atmospheric pressure for 500 hours, and Aₛ is an outer surface area of the metal component.

2. An apparatus, comprising:
a ceramic component;
a glass sealing material; and
a metal component bonded to the ceramic component via the glass sealing material,
wherein a loss in a bond strength of the apparatus is not greater than 50% after exposure of the apparatus to 1050° C. for 1000 hours or 5 cycles of a temperature change between 22° C. and 1000° C. at a ramp up rate of 5° C./min. and a ramp down rate of 5° C./min.

3. A process of forming an apparatus, comprising:
providing a ceramic component and a metal component;
placing a glass sealing material between the ceramic component and the metal component; and
heating the glass sealing material to form a bond between the ceramic component and the metal component,
wherein:
each of the ceramic component, the metal component, and the glass sealing material has a coefficient of thermal expansion that is within 4 ppm/° C. of one another, and
the metal component has a normalized weight gain less than 0.06 mg/cm²/hr or a normalized weight loss less than 0.01 mg/(cm²*hr), wherein the weight gain or the weight loss is calculated by formula ΔWₙ=(W−Wₒ)/(500Aₛ), wherein Wₒ is an original weight of the metal component, W is a weight after the metal component is exposed to 1000° C. in air at atmospheric pressure for 500 hours, and Aₛ is an outer surface area of the metal component.

4. The process of claim 3 further comprising forming an oxidized layer adjacent to the metal component, wherein said oxidized layer is formed prior to placing the glass sealing material.

5. (canceled)

6. The process of claim 4 wherein heating the glass sealing material comprises heating the glass sealing material at a first temperature and heating the glass sealing material at a second temperature that is different than the first temperature.

7. The process of claim 6, wherein the first temperature is in a range of 930° C. to 1360° C., or in a range of 1050° C. to 1310° C., or in a range of 1150° C. to 1280° C.

8. The process of claim 7, wherein the second temperature is in a range of 800° C. to 1050° C., or in a range of 825° C. to 1000° C., or in a range of 850° C. to 950° C.

9. The process of claim 3, wherein a loss in a bond strength of the apparatus is not greater than 50% after exposure of the apparatus to 1050° C. for 1000 hours or 5 cycles of a temperature change between 22° C. and 1000° C. at a ramp up rate of 5° C./min. and a ramp down rate of 5° C./min.

10. The process of claim 3, wherein the glass sealing material of the seal as initially formed comprises an amorphous phase that is not greater than 10 vol. %, not greater than 5 vol. %, not greater than 3 vol. %, not greater than 1 vol %.

11. The process of claim 3 wherein the glass sealing material of the seal comprises a sanbornite phase, a hexacelsian phase, and a barium aluminum silicate phase.

12. The process of claim 11, wherein the glass sealing material further comprises SrO, TiO₂, ZrO₂, or any combination thereof.

13. The process of claim 3, wherein each of the ceramic component, the metal component, and the glass sealing material has a coefficient of thermal expansion that is within 3 ppm/° C. of one another, or within 2 ppm/° C., or within 1 ppm/° C., or within 0.5 ppm/° C.

14. The process of claim 3, wherein the apparatus comprises a solid oxide fuel cell system, an oxygen transport membrane system, a chemical processing system, or a combination thereof.

15. An apparatus for forming a joint between a tubular ceramic component and a plurality metal component, said apparatus comprising:
a dense ceramic adapter;
a first tubular metal connector comprising proximate and distal ends wherein at least a portion of said first metal connector is contained within the bore of said dense ceramic adapter,
a second metal connector configured to receive or form a joint with said first tubular metal connector, and
a glass-ceramic sealing material,
wherein said dense ceramic adapter comprises a first female end configured to receive said tubular ceramic component, and a second female end configured to receive the proximal end of said first tubular metal connector, and
wherein the distal end of said first tubular metal connector is configured to engage the corresponding proximal end of said second tubular metal connector,
wherein said glass-ceramic seal material is disposed between the adjacent surfaces of said tubular ceramic component, said dense ceramic adaptor, and said first tubular metal connector thus forming a joint between said adjacent surfaces.

16. The apparatus of claim 15 wherein each of the ceramic components, the metal connectors, and the glass sealing material has a coefficient of thermal expansion that is within 4 ppm/° C. of one another.

17. The apparatus of claim 16 where a second metal tubular connector has a larger diameter and is configured to receive at least a portion of said first tubular metal connector that is extending from the dense ceramic adaptor, wherein said first and second tubular metal connectors are joined with a weld or a braze material forming an joint between at least a portion of the contacting or overlapping surfaces of said first and second tubular metal connectors.

18. The method of claim 17 wherein said second tubular metal connector is composed of a different material than said first tubular metal connector, wherein said material has higher strength or lower rate of creep-strain at temperatures of from about 750° C. to about 1025° C. than the material of said first tubular metal connector.

19. The apparatus of claim 15 which additionally comprises a third tubular metal connector configured to engage the corresponding proximal end of said second tubular metal connector.

20. The apparatus of claim 19 where the said second tubular metal connector is joined with the third tubular metal connector by a weld or a braze material forming an joint between the adjoining surfaces of said second and third tubular metal connectors.
